(19) United States
(12) Patent Application Publication
(10) Pub. No.: US 2019/0185249 A1
(43) Pub. Date: Jun. 20, 2019

(54) ROTABLE CAP SYSTEM FOR DISPENSING ONE OR TWO TABLETS OR CAPSULES FROM A PHARMACY VIAL

(71) Applicant: Prenith Lenear BARTLEY, Winchester, VA (US)

(72) Inventor: Prenith Lenear BARTLEY, Winchester, VA (US)

(21) Appl. No.: 16/274,160

(22) Filed: Feb. 12, 2019

Related U.S. Application Data
(63) Continuation-in-part of application No. 15/194,513, filed on Jun. 27, 2016, now abandoned.

(51) Int. Cl. B65D 83/04

(52) U.S. Cl. CPC B65D 83/0427; A61J 1/03; B65D 83/0481

(57) ABSTRACT

A cap assembly for a pill bottle to allow dispensing only one or two pills at a time. The cap assembly has an inner cap with an opening and an outer cap with a similarly shaped and sized opening and allows for a pill to be dispensed when both openings are aligned. The inner cap has a mechanism for engaging the bottle and the outer cap has a mechanism for engaging the inner cap. The cap assembly reduces the dispensing area for a pill and prevents spillage. The invention may also have a third cap to provide a child-resistance cap assembly. Alternately, the cap assembly may comprise a removable insert with a triangular opening that fits into a mouth of the pill bottle.

### CROSS-REFERENCE TO RELATED APPLICATIONS

This application is a continuation-in-part of U.S. patent application Ser. No. 15/194,513, filed Jun. 27, 2016, which claims the benefit of U.S. patent application Ser. No. 14/545,888, filed on Jun. 26, 2015, and U.S. patent application Ser. No. 14/756,555, filed on Sep. 17, 2015.

### FIELD OF THE INVENTION

The present invention relates to a bottle cap design to facilitate the dispensing of tablets or capsules from a bottle such as a pharmacy vial or a food container with pelletized food items. The inventive bottle cap design employs an inner and outer cap rotatably connected with a perforation in each cap that permits the dispensing of only one or two tablets or capsules at a time from a pill bottle when the bottle is tilted in a single action.

### BACKGROUND

In pill bottles such as bottles containing tablets and capsules (i.e., “pills”), the contents are normally dispensed by removing the cap and tilting the bottle to one side. For persons with limited dexterity, for example from arthritis, or movement disorders such as Parkinson's Disease or essential tremor, it can be a challenge to dispense one or two pills from a bottle without spilling the entire contents. Typically, patients only use one or two pills at a time from a pharmacy bottle.

The difficulty of opening and dispensing pills from pharmacy bottles is an art-recognized problem. See, for example, A. Beckman et al., “The difficulty of opening medicine containers in old age: a population-based study,” Pharm World Sci. 2005, 27(5), 393-8, DOI: 10.1007/s11096-005-7903-z; K. Nortenboom et al., “Practical Problems with Medication Use that Older People Experience: A Qualitative Study,” J. Am. Geriatrics Soc. 2014, 62, 2339-2344, DOI: 10.1111/jgs.13126. Nortenboom specifically calls out the difficulty of removing medicine from a bottle, the problem addressed by this invention.

Pill bottles with various safety cap designs are well known. See, for example, U.S. Pat. No. 8,267,265. Most of these are either difficult to operate, for example, child resistant caps requiring certain force to open the cap or once opened they allow unrestricted access to the pills inside the bottle. This results in unnecessary access to entire contents of the bottle as well as unintentional spillage of pills, a particular problem for persons with a movement disorder.

The use of a choke to narrow the opening of a bottle is well known with powdered products such as spices. See, for example, U.S. Pat. Nos. 4,437,593, 4,449,638, and 5,213,238. These products are intended for the controlled dispensing of larger objects that do not flow freely, such as tablets, capsules, or pelletized food items.

In addition, various specialty cap designs may be of value for pelletized food items, such as chewing gum products or candy, for example “M&M®” candy, that limit the egress of the food product from the packaging.

### SUMMARY OF THE INVENTION

This invention provides means to limit the egress of pills from a pharmacy vial, particularly for the benefit of mobility impaired persons. In addition, this device may have utility to limit the egress of pelletized food items from a food package.

Accordingly, a cap assembly is provided for limiting the egress of tablets or capsules from a pharmaceutical bottle containing tablets or capsules. In an embodiment, the assembly may include an inner cap having a first top panel with an extended shoulder, a first opening contained in the first top panel, and a first skirt extending downward from the first top panel, the first skirt having an inner surface with a mechanism for engaging a neck of the bottle. The assembly may also have an outer cap over the inner cap, wherein the outer cap engages the inner cap, wherein the outer cap has a second top panel, and a second opening in the second top panel, wherein the second opening is approximately the same size and shape as the first opening, and a second skirt extending downward from the second top panel, the second skirt having an inner surface with a mechanism for engaging the inner cap and an outer surface with one or more ridges for providing a non-slip grip. In an embodiment, the outer cap is rotatable relative to the inner cap between a first position wherein the openings are not aligned, and a second position wherein the second opening aligns with the first opening. In an embodiment, when the outer cap is in the second rotable position, when the bottle is tilted in a single movement, one or two tablets or capsules are dispensed through the aligned openings. The same principle of operation applies if the bottle or other package contains a pelletized food item.

### BRIEF DESCRIPTION OF THE DRAWINGS

FIG. 1 is a cross-section view of a pill bottle cap with a two-cap assembly, in accordance with one embodiment of the invention, shown in an installed and locked position on the pill bottle.

FIG. 1A is a perspective view of a pill bottle of this invention, showing the openings in the inner and outer caps to allow pills to dispense from the bottle.

FIG. 1B is a perspective view of a pill bottle of this invention, showing the openings in the inner and outer caps out of alignment.

FIG. 1C is a view of the bottle cap only, showing the openings of the inner and outer cap in an oval-shaped embodiment.

FIG. 2A is a cross-section view of a pill bottle cap and the bottle showing an inner cap of the two-cap assembly of FIG. 1, in accordance with one embodiment of the invention.

FIG. 2B is a top plan view of the inner cap of FIG. 2A, in accordance with one embodiment of the invention.

FIG. 3A is a cross-section view of a pill bottle cap and the bottle showing the two-cap assembly of FIG. 1 in an unlocked position, in accordance with one embodiment of the invention.

FIG. 3B is a top plan view of the two-cap assembly of FIG. 3A, in accordance with one embodiment of the invention.

FIG. 4A is a perspective view of a pill bottle cap and the bottle showing the two-cap assembly of FIG. 1 in a locked position, in accordance with another embodiment of the invention.

FIG. 4B is a top plan view of the two-cap assembly of FIG. 4A, in accordance with another embodiment of the invention.

FIG. 4C is a cross-sectional view of the two-cap assembly of FIG. 4A, in accordance with another embodiment of the invention.

FIG. 5A is a cross-section view of a pill bottle cap and the bottle showing the two-cap assembly of FIG. 1 in a locked position, in accordance with yet another embodiment of the invention with a push-to-turn feature.

FIG. 5B shows the inner cap with a push to turn embodiment, including locking lug 110m.

FIG. 5C shows the cap from FIG. 5B but in an upside-down view to show lugs on the interior surface of skirt 110b.

FIG. 5D shows an upside-down view of the outer cap of the embodiment of FIGS. 5A-5C, showing a lug on the interior surface of the skirt 120b.

### DETAILED DESCRIPTION OF THE INVENTION

The term “pill” as used herein refers to pills, tablets, capsules, caplets and other such solid medicine forms. The term “bottle” as used herein refers to bottles or vials, and any such other container with a cap that holds pills or a pelletized food item.

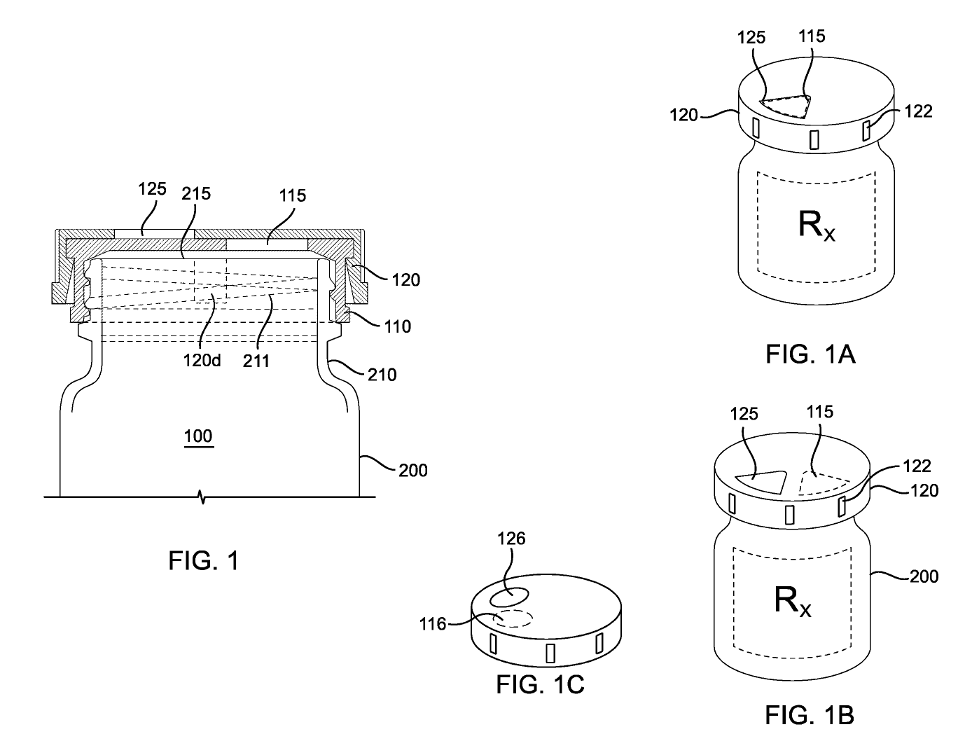

An embodiment of this invention is shown in FIG. 1, illustrating an exemplary pill bottle cap assembly 100. The cap assembly 100 includes an inner cap 110 and an outer cap 120. Outer cap 120 is rotatable relative to inner cap 110, such that a single opening in each cap can come into alignment when outer cap 120 is rotated. The inner cap contains a single opening 115 for dispensing pills. As depicted in FIGS. 1A and 1B, the opening is triangular, but other shapes are possible, for example an oval shape shown as 116/126 in FIG. 1C. In an embodiment, the outer cap 120 has a similarly shaped and sized single opening 125 or 126 as opening 115 or 116.

The cap assembly 100 fits over a bottle, vial, or other package with a rigid neck 210, such as a pill bottle 200. Cap assembly 100 includes an inner cap 110 and an outer cap 120. Inner cap member 110 includes a skirt 110b that envelopes neck 210. Skirt 110b further includes means for engaging neck 210 to securely affix inner cap 110 to neck 210. In an embodiment, inner cap 110 engages threads 211 on the bottle neck 210. Other engagement means are known to persons of skill in the art for securely engaging a cap member to the neck of a bottle, for example a system of lugs and snaps.

Outer cap 120 fits over inner cap 110. Outer cap 120 includes a top surface 120a with an opening 125 or 126 for dispensing the pill or pelletized food product. In an embodiment, opening 125 or 126 is approximately the same size and shape as opening 115 or 116 in inner cap 110. Top surface 120a may have some flex and can bow slightly inward, which may be necessary in some embodiments of the engagement mechanism between 120 and 110. Outer cap 120 also includes an outer skirt 120b that envelopes the inner skirt 110b.

When the openings 115/116 and 125/126 in both caps are aligned with each other and the opening 215 of the bottle, the bottle is unlocked and the pills from the bottle may be dispensed when the bottle is tilted. Thus, the outer cap is rotatable relative to the inner cap between a first position wherein the openings 115/116 and 125/126 are not aligned, and a second position wherein the second opening 125/126 aligns with the first opening 115/116. The rotatability of the outer cap 120 is illustrated in FIGS. 1A and 1B. In FIG. 1A, the caps are in the aligned orientation. In FIG. 1B, outer cap 120 is positioned to that opening 125 is not aligned with opening 115, shown in dashed lines. When the openings in the caps are not aligned, the package 200 is sealed shut. In an embodiment, the openings 115/116 and 125/126 are sized such that only one or two tablets, capsules, or food pellets will pass through the opening. In an embodiment this may require different sized openings for different products to achieve the desired degree of egress.

In an embodiment, non-slip grip ridges 122 are provided on the exterior of the skirt 120b of outer cap 120.

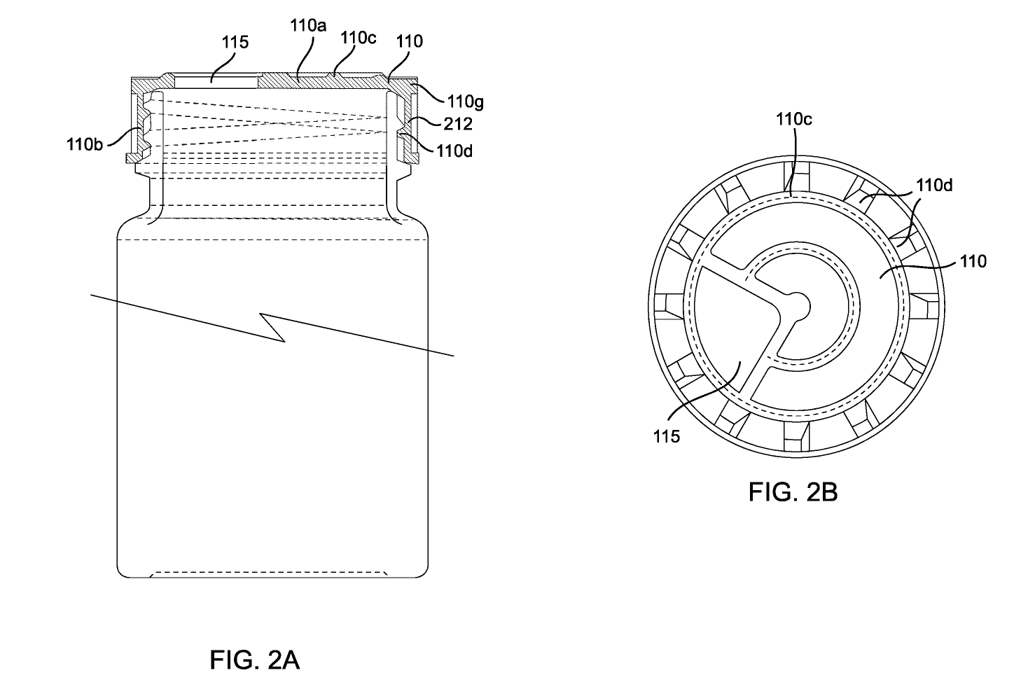

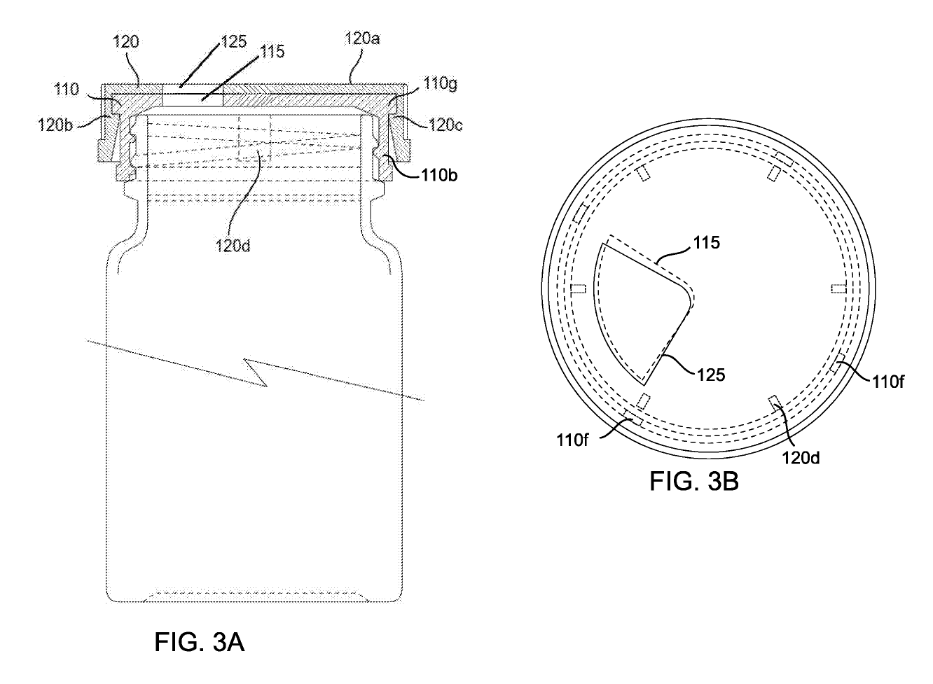

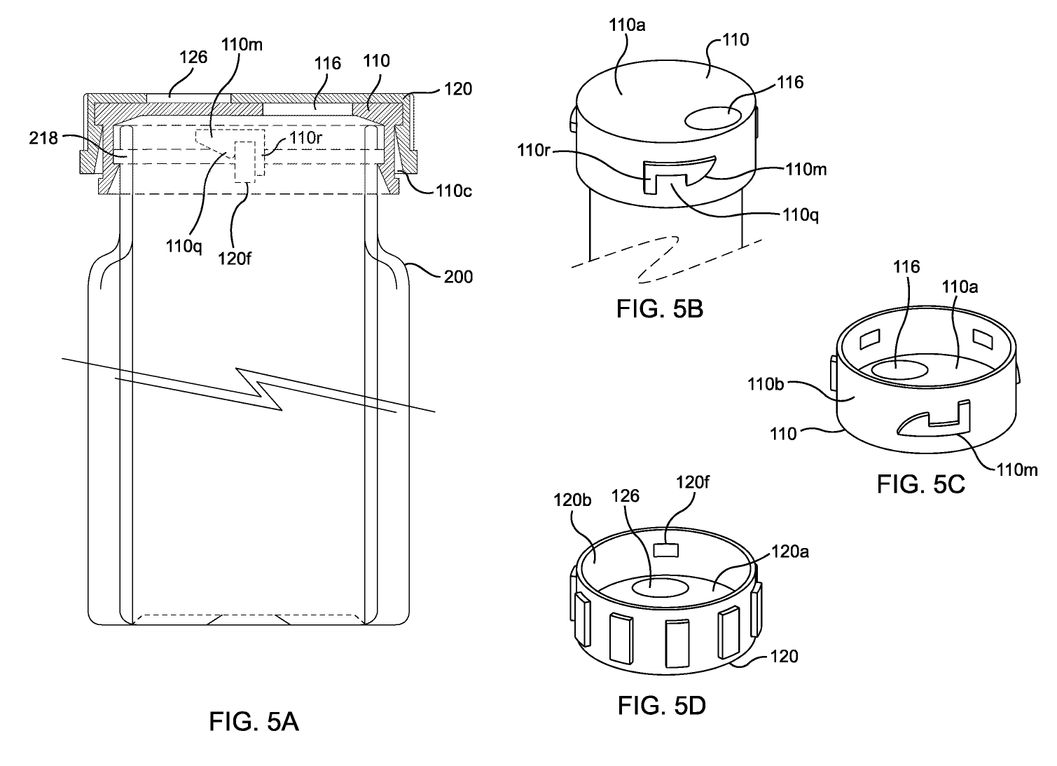

The outer surface of skirt 110b includes means for engaging outer cap 120. In an embodiment, outer cap 120 is not normally removed from inner cap 110. In an embodiment, inner cap 110 includes an extended shoulder 110g (FIGS. 2A and 3A) that engages the outer cap. Other engaging means are possible. In an embodiment, the outer surface of skirt 110b has one or two locking lugs 110m (FIG. 5A) with a locking notch 110q and a tab 120f positioned on the inner surface of outer skirt 120b that fits into the locking notch, such that the outer cap must be depressed before the other cap can rotate. In an embodiment, locking lug 110m also has a stop 110r that prevents the outer cap from freely rotating past that point. In an embodiment with two locking lugs 110m, the outer cap will only be able to rotate 180 degrees before tab 120f engages a stop 110r.

The action of depressing outer cap 120 before it will rotate, as described in the foregoing paragraph, may satisfy the child resistant packaging requirements in 16 CFR 1700, to reduce the likelihood of a young child or an incompetent person from rotating outer cap 120 and accessing the contents of the pharmaceutical vial without supervision.

The design of the cap assembly with the reduced dispensing opening defined by openings 115/116 and 125/126 allows only one or two pills to be dispensed each time when the bottle is tilted to the side by a user. In an embodiment, the size of the opening accommodates only one pill at a time. In another embodiment, the size of the opening accommodates only two pills. For example, opening 115 may be ½ inch by ¾ inch and opening 125 may be 17/32 inch by 13/16 inch. This minimizes any accidental or unintentional spillage of pills. Pills are accessed by the user by rotating or twisting the individual assembled caps 110 and 120 to align the openings 115 and 125 in the two-cap assembly. A counter-rotation or twist of the outer cap recloses the openings. The two caps in the cap assembly 100 can be scaled up or down to adapt to any size or any shape pill bottle. To further reduce pill spillage, the user can intentionally misalign one of the cap openings thereby reducing the open area for pill dispensing.

FIGS. 1A and 1B are perspective views of the inventive cap assembly in place on a pill bottle 200. The outer cap 120 is visible on the top of the bottle. In FIG. 1A, the inner and outer caps are aligned such that openings 115 and 125 are aligned. In this position, tilting the bottle one side controls the egress of pills from the bottle, so that only one or two pills are dispensed at a time. FIG. 1B shows the outer cap twisted relative to the inner cap so that the openings 115 and 125 are not aligned. Opening 115 is depicted in dashed lines indicated it is hidden from view. In this position, the top of the bottle is sealed. Thus, FIG. 1B is the normal closed position used when the bottle is in storage.

FIG. 2A is a cross-section view of a pill bottle cap and the bottle showing only the inner cap 110 of the two-cap assembly 100 of the invention. The inner cap 110 comprises a top panel 110a and a side skirt 110b extending downwards from the top panel for covering and sealing the bottle at its threaded neck. The top panel may have an extended shoulder 110g that engages outer cap 120. In an embodiment, the inner cap 110 may have one or more raised areas 110c molded into the top of the cap to provide moisture resistance to the cap seal, e.g., one or more moisture seal rings. The inner cap may have a mechanism for engaging the bottle neck. For example, the inner cap may have one or more ridges or snap locks 110d for engaging the threads, neck ring, snap ring, snap lock or lugs of the bottle neck, depicted generically as 212 in FIG. 2A. FIG. 2B shows a top plan view of the inner cap 110 with a rounded triangular opening 115. The inner cap may have a plurality of locking pockets 110d. The inner cap may have snap locks, e.g., four snap locks 110f as shown in FIG. 3B. The inner cap will move a set distance before it locks depending on the size and shape of the bottle neck. These adjustments are well-known in the art.

FIG. 3A is a cross-section view of a pill bottle cap and the bottle showing the outer cap 120 of the two-cap assembly 100 in an unlocked or open position, in accordance with one embodiment of the invention. FIG. 3B shows a top plan view of the outer cap 120 with the rounded triangular opening 125 in near alignment with inner opening 115. FIG. 3A shows and embodiment of an engagement mechanism between inner cap 110 and outer cap 120 with one or more grooves 120c or molded drive lugs 120d that snap over the extended shoulder 110g of the top panel of the inner cap and hold the outer cap in place while rotating freely. For example, the outer cap may have six locking drive lugs. In a further embodiment, a moisture seal may be interposed between the inner and outer caps.

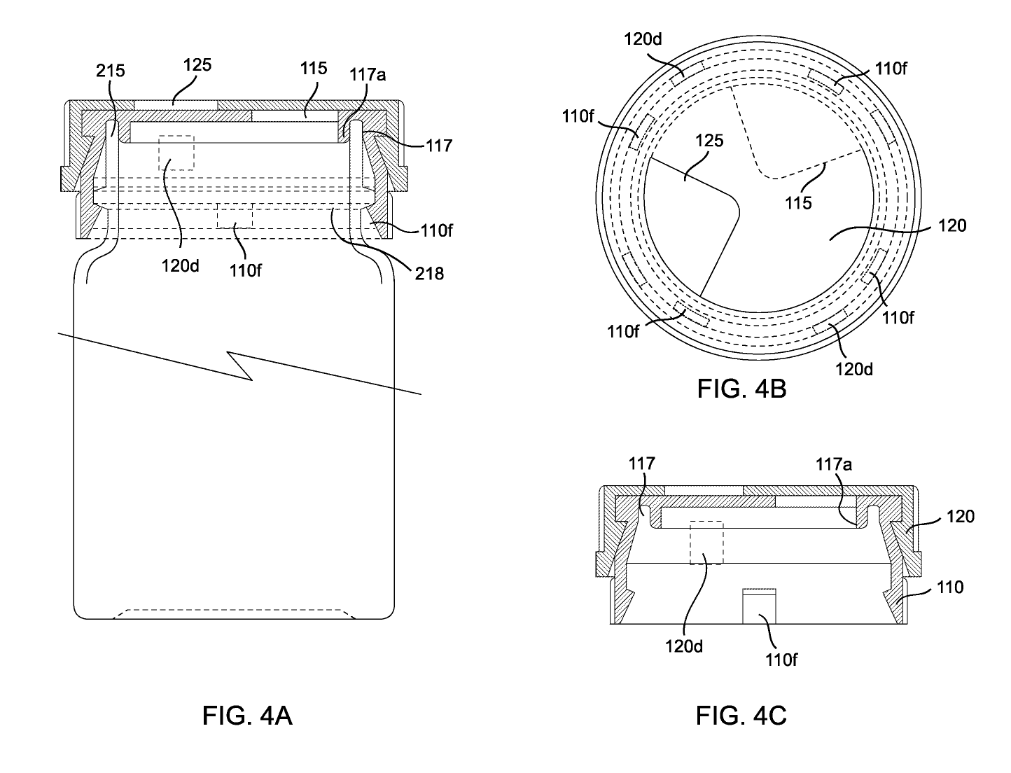

With reference to FIG. 4A, another embodiment of the two-cap assembly 100 is shown in a vial 200 without a threaded neck. FIGS. 4B-4C show alternate views of the two-cap assembly of FIG. 4A. In this embodiment, four snap locks 110f on the inner cap 110 are designed to snugly snap over a neck ring or snap ring 218 of on the neck of the vial. A snap lock 110f is shown on the inside surface of inner cap 110. Drive lug 120d is depicted (in dashed lines) on the inside surface of outer cap 120, engaging outer cap 120 and inner cap 110. Note too in the embodiment shown in FIGS. 4A and 4C that the rim 215 of vial 200 nests inside a circumferential groove in 117 and an inner neck member 117a nests inside the rim of the vial.

With reference to FIG. 5A, the two-cap assembly 100 is shown in a locked position, in accordance with another embodiment of the invention particularly suited to a child resistant opening. This embodiment depicts a circumferential ring 218 and lugs 110f that engage the inner cap 110 to vial 200. In this embodiment, the outer surface of inner cap skirt 110b has locking lugs 110m with a shape as shown, with notch 110q and stop tab 110r. In this embodiment, the tabs 120f on the inside surface of outer cap skirt 120b are designed to interact with lugs 110m (i.e., seats) on the outer surface of skirt 110b. In the locked position, tab 120f is seated in notch 110q and outer cap 120 is locked in position. Simply rotating outer cap is not possible. In order to rotate outer cap 120 and expose the openings in alignment, outer cap 120 must be depressed and rotated at the same time. This forces tab 120f downward and away from tab stop 110r. Conventional pharmacy vials may have 4-6 similar locking lugs, but in this invention the outer cap 120 is not disengaged from inner cap 110, and the holes e.g. 115/125 must be brought into alignment, so there can only be one to three lugs 110m. With two lugs 110m, the outer cap 120 is rotatable 180°.

This embodiment is shown in further detail in FIGS. 5B-5D. FIG. 5B depicts the inner cap without the outer cap, showing locking lug 110m on skirt 110b. FIG. 5C is view of inner cap 110 upside down, i.e., the top panel is at the bottom. This also shows lug 110m. FIG. 5D shows an upside-down view of outer cap 120 detached from inner cap 110, showing tab 120f in the inside surface of skirt 120b.

Thus, the two-cap assembly provides a user with a reduced opening for dispensing that minimizes accidental spillage of pills. The actual opening may be set to only be big enough for one pill. Or it may be adjusted to a smaller opening to deliver only one or two pills, regardless of the pill size, by intentionally not fully aligning the cap openings. In the normal closed or locked position, the opening 125 in the outer cap is fully out of alignment with the opening 115 in the inner cap. The inner cap is designed to be firmly tightened or snapped into place using either the threaded or four snap or six snap cap lock design depending on the bottle style. The inner cap may be configured so that it does not need to be removed once properly in place. The outer cap 120 may have finger grip ridges on the outside of the cap edge to provide a non-slip grip so that the reduced pill opening on the inner cap comes into alignment for quick and easy pill dispensing. A gentle twist of the outer cap recloses the pill bottle. The cap assembly may be disposable and discarded when the pill bottle is empty. The cap assembly of the invention may be installed by pharmacists when completing a prescription or installed by a user on any existing pill bottle.

1-12. canceled

13. A cap assembly for limiting the egress of tablets or capsules from a pharmaceutical bottle containing tablets or capsules comprising:
an inner cap comprising a first top panel with an extended shoulder, a first opening contained in the first top panel, and a first skirt extending downward from the first top panel, the first skirt having an inner surface with a mechanism for engaging a neck of the bottle; and
an outer cap over the inner cap, wherein the outer cap engages the inner cap, wherein the outer cap comprises a second top panel, a second opening contained in the second top panel, wherein the second opening is approximately the same size and shape as the first opening, and a second skirt extending downward from the second top panel, the second skirt having an inner surface with a mechanism for engaging the inner cap and an outer surface with one or more ridges for providing a non-slip grip;
wherein the outer cap is rotatable relative to the inner cap between a first position wherein the openings are not aligned, and a second position wherein the second opening aligns with the first opening;
wherein when the outer cap is in the second position, on tilting the bottle in a single movement, one or two tablets or capsules are dispensed through the aligned openings.

14. The cap assembly of claim 13 wherein the first and second openings for dispensing are shaped as rounded triangles or have an oval shape.

15. The cap assembly of claim 13, wherein the outer surface of the first top panel has one or more raised areas for sealing moisture in the bottle.

16. The cap assembly of claim 13, wherein an outer surface of the first skirt has two locking lugs with a locking notch such that the outer cap must be depressed before the other cap can rotate.

17. The cap assembly of claim 13, wherein the mechanism for engaging the bottle neck comprises a plurality of snap locks to attach to one or more neck rings of the bottle.

18. The cap assembly of claim 13, wherein the mechanism for engaging the bottle neck comprises a plurality of snap locks to attach to one or more lugs of the bottle neck.

19. The cap assembly of claim 13, wherein the mechanism for engaging the inner cap comprises a plurality of snap locks.
